(19) United States
(12) Patent Application Publication
(10) Pub. No.: US 2002/0184845 A1
(43) Pub. Date: Dec. 12, 2002

(54) Methods and apparatuses for securing a frame/panel to a substrate

(76) Inventor: David Paul Horowitz, New York, NY (US)

Correspondence Address: Robert L. Powley, Esq., Law Office of Robert L. Powley, pc, 14th Floor, Suite 14-334, 1633 Broadway, New York, NY, 10019, US

(21) Appl. No.: 10/162,847

(22) Filed: Jun. 5, 2002

Related U.S. Application Data
(60) Provisional application No. 60/296,419, filed on Jun. 6, 2001.

(51) Int. Cl. E06B 3/28

(52) U.S. Cl. 52/489.2; 52/203; 52/769; 52/511

(57) ABSTRACT

Methods and apparatuses directed to a system for releasably securing a frame/panel (wall system) to a substrate or wall. The system includes a first rod affixed to the wall in a substantially horizontal direction for securing a top portion of a frame, where the frame comprises a perimeter of polygonal or irregular shape. The system also includes a second rod spaced apart from the first rod and affixed to the wall in a substantially horizontal direction for securing a bottom portion of the frame. Each rod includes a substantially cylindrical shape having a substantially fixed curved surface throughout corresponding substantially to a predetermined diameter and including a length which is equal to or less than a width of the frame. The system also includes a plurality of clips affixed to an affixing side of the frame creating an affixable frame. Each clip includes a shape substantially corresponding to the curved surface of the rod and comprising a receiving side having two flexible arms spaced apart from one another a distance being equal to or less than the predetermined diameter. Each arm includes a housing portion for housing the rod therein. Moreover, the clips are arranged on the affixing side of the panel to correspond to the first and second rods such that at least two clips correspond to each rod and at least one clip is affixed to each corner of the frame.

### RELATED APPLICATIONS

This application claims benefit under 35 U.S.C. § 119(e) of U.S. Provisional Application No. 60/296,419, filed Jun. 6, 2001, the entire disclosure of which is herein incorporated by reference.

### BACKGROUND OF THE INVENTION

1. Field of the Invention

The invention is related to securing systems in general and more particularly to an innovative system for removably installing custom wall/panel surfaces to a wall.

2. The Prior Art

In the past, securing a panel, frame or surface to a substrate or wall was accomplished in one of two methods, both of which suffer from a common problem of being labor intensive.

The first method is directed to a front mounting or straight-on mounting of panels using glue, grout and/or mullions to lock the pieces into place on an existing substrate. An advantage of this method is that, for example, a floor, baseboard, ceiling line, lighting cove, ornamental detail and the like need not to be connected to the relevant wall surface (the panels are independent of its surroundings). In addition, such installations are independent of other details. However, a downside to this method is that the panels are permanently mounted and the panels require mounting onto an existing, continuous surface/substrate.

A second method for securing a panel to a substrate is by using a hook or “Z” clip. Accordingly, an advantage of this method is that grout and/or fasteners (nuts, bolts, screws and the like) cannot be seen. Although, advantageously, the panels are removable, it is at great expense. Specifically, all other panels connected to a particular panel need to be removed. Moreover, this method compromises the ability to mount lighting, coves, architectural details, baseboards and the like side-to-side or up and down (the panels are not independent of their surroundings).

Accordingly, there exists a need for a simple panel securing system which is less labor intensive, is removable and preferably allows each panel to be independent of its surroundings.

### SUMMARY OF THE INVENTION

Accordingly, it is an object of the present invention to present a releasable securing system for hanging and/or securing panels/frames to a substrate. The systems and methods according to the present invention provide for a much simpler installation, are easily removable and less labor intensive.

The substrate for use with the mounting systems and methods according to the present invention may include any natural and/or man made material. The substrate may be a vertically inclined surface such as a wall.

The methods and systems for securing panels to a substrate according to the present invention provides the advantages of both prior art securing systems stated earlier. Specifically, in the present invention, no unsightly mounting materials and/or fasteners are used. Moreover, panels affixed to a substrate according to the present invention allows the surface to operate separately from the floors and ceilings.

Panels mounted according to the present invention may also be removed, moved or replaced individually.

Accordingly, in a first aspect of the present invention, a method for securing a frame to a substrate includes affixing a rod to a wall for securing a frame, affixing at least one flexible clip to an affixing side of the frame creating an affixable frame, engaging the clip in contact with the rod and forcing the affixable frame towards the rod. The flexible clip flexes to receive and secure the rod therein.

In another aspect of the present invention, a method for releasably securing a frame to a wall includes affixing a first substantially linear rod to a wall in a substantially horizontal direction for securing a top portion of the frame and affixing a second substantially linear rod to a wall in a substantially horizontal direction for securing a bottom portion of the frame. The second rod is spaced away from the first rod and each rod includes a substantially cylindrical shape having a substantially fixed curved surface throughout corresponding substantially to a predetermined diameter and including a length which is equal to or less than a width of the panel. The method further includes affixing a plurality of clips to an affixing side of the frame creating an affixable frame. Each clip includes a shape substantially corresponding to the curved surface of the rod and comprising a receiving side having two flexible arms spaced apart from one another a distance being equal to or less than the predetermined diameter. Each arm includes a housing portion for housing the rod. At least one clip is substantially positioned in each corner of the frame on the affixing side of the frame such that each clip in each top corner of the frame and corresponds to the first rod and such that each clip in each bottom corner of the frame corresponds to the second rod. The method further includes engaging the receiving side of at least the clips positioned in the top corners of the frame or the clips positioned in the bottom corners of the frame in contact with a respective rod and forcing the affixable frame towards the rod at the particular clips engaging a respective rod. The flexible arms are forced apart to receive the rod therebetween and rest within the housing portion of each flexible arm.

To release the frame from the wall in the above embodiment, the method further comprises placing a force on the panel in a direction away from the wall thereby compelling the flexible arms of each clip to move apart. This allows the rod to pass out of the housing portion and release the frame from the wall.

In yet another aspect of the present invention, a system for securing a frame to a wall includes a rod affixed to a substrate for securing a frame thereto and at least one flexible clip affixed to an affixing side of the frame creating an affixable frame.

In yet another aspect of the present invention, a system for releasably securing a frame to a wall includes a first rod affixed to a wall in a substantially horizontal direction for securing a top portion of a frame, where the frame comprises a perimeter of polygonal or irregular shape and a second rod spaced apart from the first rod and affixed to the wall in a substantially horizontal direction for securing a bottom portion of the frame. Each rod includes a substantially cylindrical shape having a substantially fixed curved surface throughout corresponding substantially to a predetermined diameter and including a length which is equal to or less than a width of the frame. The system also includes a plurality of clips affixed to an affixing side of the frame creating an affixable frame. Each clip includes a shape substantially corresponding to the curved surface of the rod and comprising a receiving side having two flexible arms spaced apart from one another a distance being equal to or less than the predetermined diameter. Each arm includes a housing portion for housing the rod therein. Moreover, the clips are arranged on the affixing side of the panel to correspond to the first and second rods such that at least two clips correspond to each rod and at least one clip is affixed to each corner of the frame.

In still yet another aspect of the present invention, a frame for securing to a substrate includes at least one flexible clip affixed to an affixing side of a frame creating an affixable frame. The clip receives a rod which is affixed to a substrate for securing the frame thereto.

In still yet another aspect of the present invention, a releasably secured frame includes a frame comprising a perimeter of a polygonal or irregular shape and a plurality of clips affixed to an affixing side of a frame creating an affixable frame. The clips are arranged on the affixing side of the frame to correspond to a first mounting rod affixed to a wall for securing a top portion of the frame and a second mounting rod affixed to the wall for securing a bottom portion of the frame. In addition, each rod includes a predetermined diameter and having a curved surface and each clip includes a shape substantially corresponding to the curved surface of each mounting rod and comprising a receiving side having two flexible arms spaced apart from one another a distance being equal to or less than the predetermined diameter. Each arm includes a housing portion for housing the mounting rod therein and at least two clips correspond to each rod and wherein at least one clip is affixed to a predetermined portion of the frame.

The above objects and aspects of the present invention will be more clearly understood with reference to the drawings included in the present application (and briefly described below) and the following detailed description set out below.

### BRIERF DESCRIPTION OF THE DRAWINGS

FIG. 1A illustrates a front view of the mounting system according to one embodiment of the present invention.

FIG. 1B illustrates a side view of the mounting system according to one embodiment of the present invention

FIG. 2 illustrates an enlarged top view of a corner of a frame for securing a clip according to one embodiment for the present invention.

FIG. 3A illustrates a side view of the clip for affixing to a panel/frame according to one embodiment of the present invention.

FIG. 3B illustrates a side view of the clip affixed to structure.

FIG. 4 illustrates a top-plan view of an affixing portion for the clip illustrated in FIGS. 3A and 3B.

FIG. 5 illustrates a cross-sectional view of a securing rod according to one embodiment for the present invention.

FIG. 6 illustrates a top-plan view of the securing rod according to one embodiment for the present invention.

FIG. 7 illustrates an enlarged side view of a corner of a panel/frame containing an affixed clip for the mounting system according to one embodiment of the present invention.

### DETAILED DESCRIPTION OF THE PREFERRED EMBODIMENTS

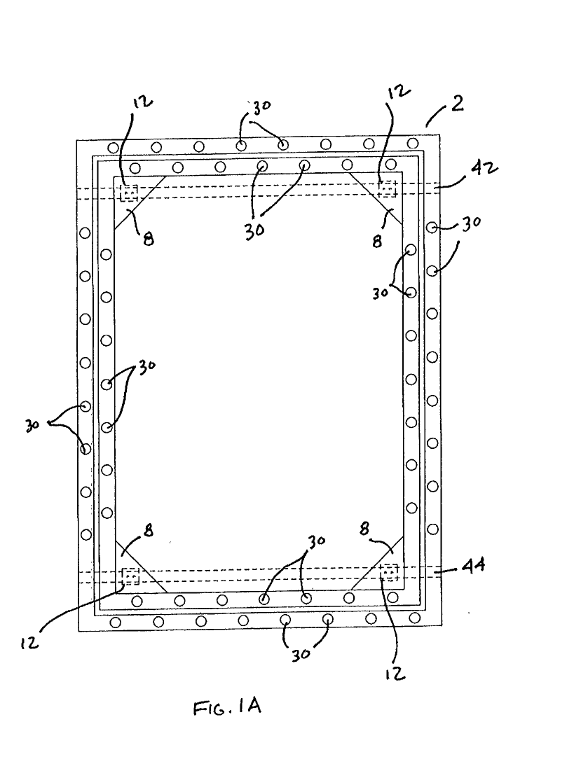

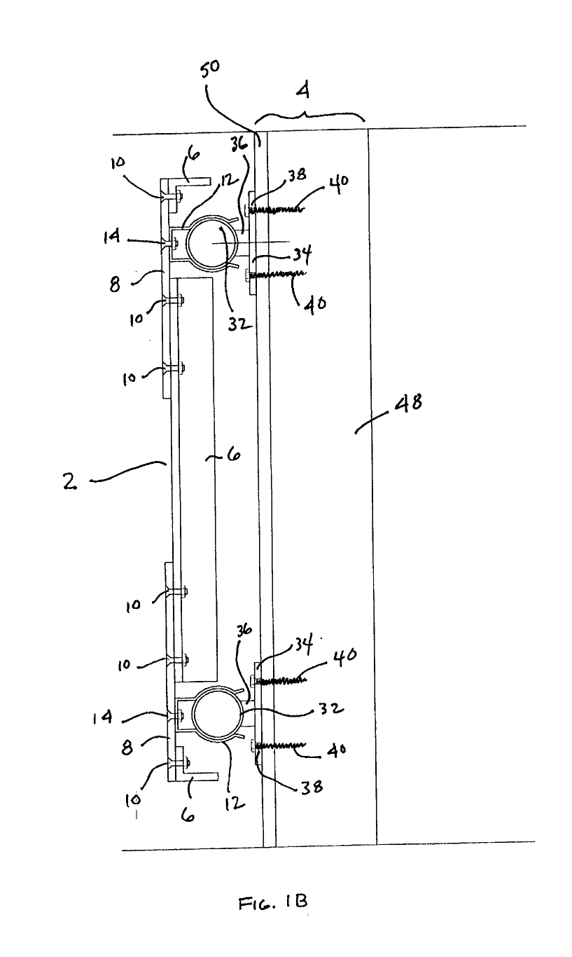

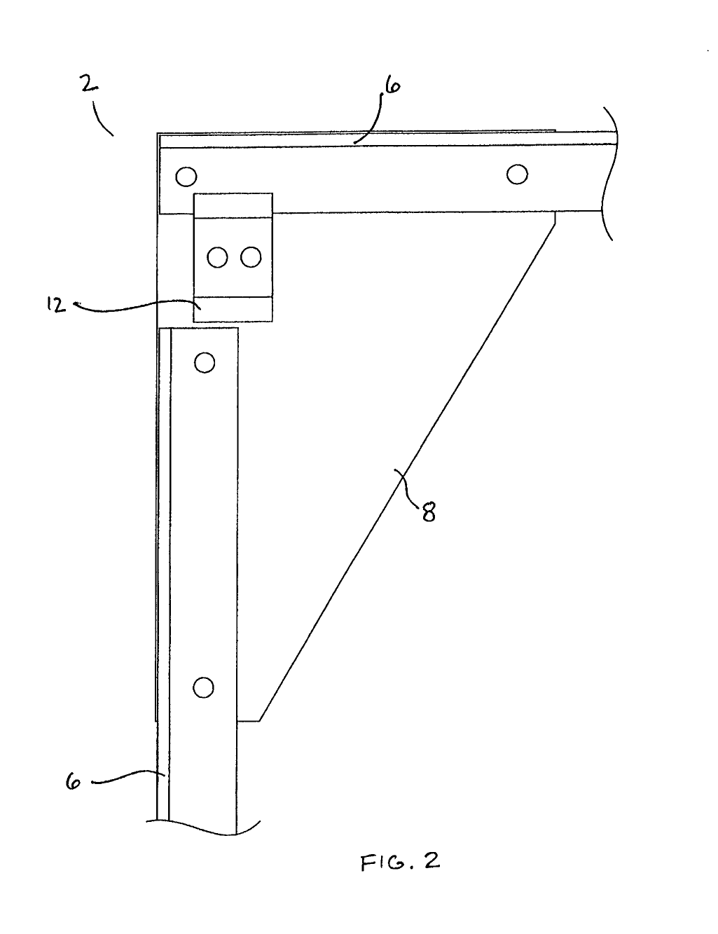

As shown in FIGS. 1-2 and 7, a frame 2 is affixed to a substrate 4. The frame may be a wall panel, or may be affixed to another material such as wood, plastic, metal, plaster, and the like. As shown, the frame is rectangular in shape and includes angle irons or “T-stock” 6 on all four sides. The shape of the frame may also include a triangular, square, oval, circular, polygonal and irregular shape. The T-stock may be made of any structural material including any steel, aluminum and the like, but may also be made of wood, plastic, fiberglass and graphite.

Preferably, in each corner of the frame are triangular reinforcement 8 which acts as an attachment point to affix the T-stock thereto via fasteners 10 and also to stabilize the frame to make it more rigid and inflexible.

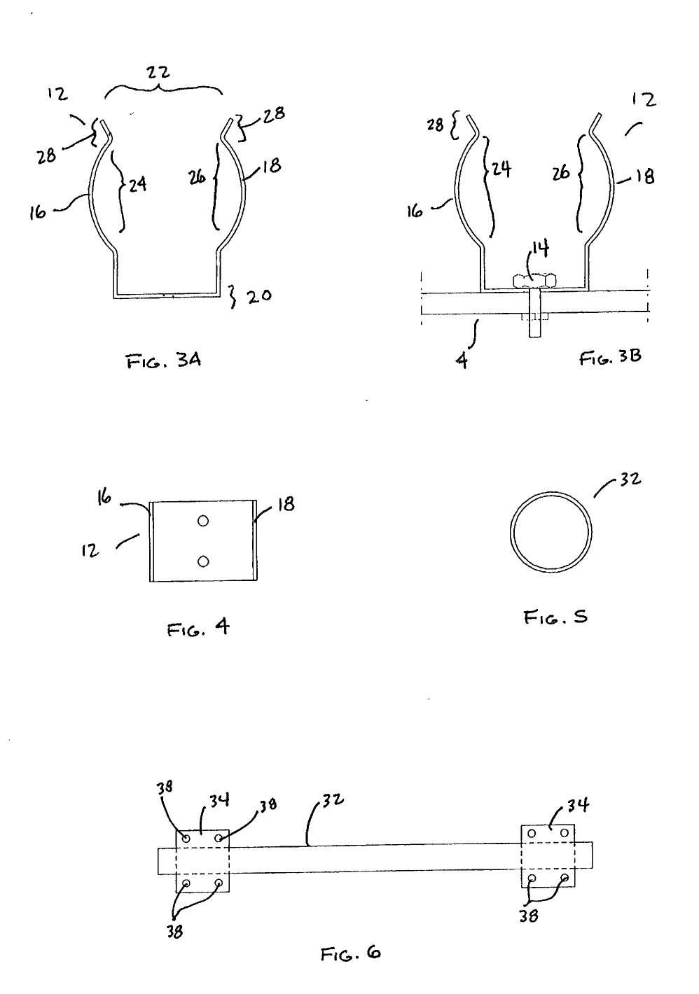

Affixed at each corner of the frame is a mounting spring clamp or clip 12 which may be secured to the triangular reinforcement via fasteners 14. The clip, as shown in FIGS. 3-4 (FIG. 4 illustrating an attachment end of the clip only), includes flexible arms 16 and 18 on either side which are shaped to receive a round support rod, which are joined at an attachment end 20 and open at a receiving end 22. Housing portions 24 and 26 are formed between the receiving end 22 and the attachment end 20. At the end of each arm at the receiving end 22 is preferably a bent portion 28, where an initial portion of the arm is bent away from an interior center of the clip (between the two arms). This allows the clip to initially receive the support rod where an opening formed by the curved surface of each flexible arm is smaller than the mounting rod making it somewhat more difficult for the rod to be received in the housing portions.

The clip is made preferably of a spring-like steel (with associated properties) to form the clamp like mechanism necessary to secure the mounting rod, such that the arms flex away from each other when the receiving rod is forced into the clip at the receiving end through application of a preferably straight-on mounting force. Specifically, a perpendicular force placed upon the corner of the frame spreads the flexible arms apart, allowing the receiving rod to pass from the receiving end and into the housing portion of each arm. Accordingly, once the mounting rod is received by the housing portions of each arm, the arms are still preferably in a slightly flexed state such that pressure from the flexed arm is placed against the mounting rod at the housing portion. This insures a tight, snug fit such that the mounting rod cannot fall out of the housing portion with little effort.

The T-stock of the frame may also include one or more holes 30 (preferably a plurality of holes) to receive the flow-through of plaster poured on and around the frame. Plaster, for example, is used as an artwork or decorative detail in a panel to be mounted to the substrate. Thus, the frame and clips are setup to receive the plaster such that the only part of the frame remaining thereafter is the clips.

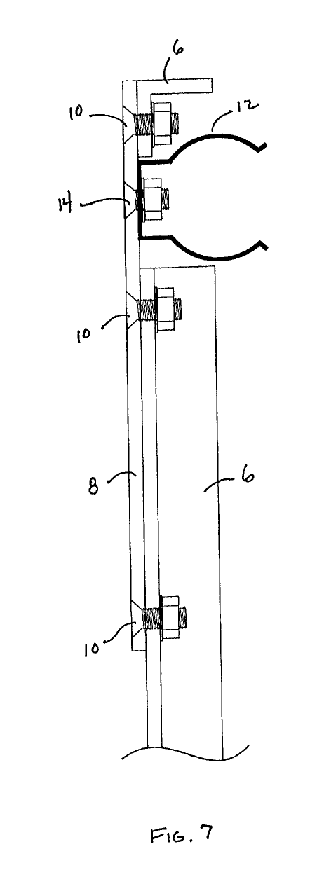

One of the other integral parts of the mounting system and method is the mounting rod 32 shown in FIGS. 1B, 5 and 6. Preferably, two mounting rods are used in mounting a frame to a substrate: one to secure the top of the frame and a second to secure the bottom of the frame. As shown in FIGS. 5 and 6, the mounting rod 32 is a cylindrical rod (preferably hollow, but may be solid) having a shape which is preferably only slightly larger than the distance between the flexible arms of the mounting clip. To that end, the curved surface of the rod substantially matches the curved shape of the housing portion of each flexible arm.

Accordingly, the mounting rod in the present invention is secured to a substrate, such as a wall (in a preferably level, horizontal position) in a desired location. The mounting rod thus requires fastening means for such attachment. Such attachment means may be simply a hole drilled through the rod such that a screw, lag or other fastener can secure the rod to the substrate. As shown in the figures, the rod may be mounted to a mounting plate 34 and may be spaced apart therefrom with a spacer 36. The mounting of the rod to the plate may be via welding, a fixture member for receiving the rod (similar to the mounting clip for example) or using a fastener (not shown). The plate includes holes 38 for fasteners 40 such that it may be fastened to the substrate.

As shown in FIG. 1A, upper 42 and lower 44 mounting rods are affixed to a wall via fasteners 40 (screw, lags, nut-bolt, and the like). The wall includes studs 48, to supply adequate support for receiving fasteners, and wall board 50.

To mount the frame onto the mounting rods, the frame is positioned such that the receiving ends (and in particular, the bent ends of each flexible arm) initially receive the mounting rod. Preferably, only one end is attached at a time, such that, for example, the clips for the upper end of the frame are engaged to the mounting rod first (although one may secure the lower end first if desired). Preferably, both clips at each corner of one end are engaged with the mounting rod together.

Once the rod is received in the receiving end of the respective clips, the installer pushes on the respective end in a perpendicular direction to the center line of the clip (between the two arms). This force compels the flexible arms away from one another, which allows the mounting rod to pass from the receiving end of the clip and into the housing portion of each flexible arm. As previously stated, since the mounting rod diameter is slightly larger (preferably) than the distance between the flexible arms in a non-stressed position, the clip places the mounting rod under slight pressure so as to yield a retaining force thereon. Thereafter, the installer repeats the process for the remaining end of the frame. The frame is thus secured to the substrate.

To remove the frame from the mounting rod, a force in a direction away from the substrate is applied to the frame. This forces the flexible arms away from one another thereby releasing the mounting rod from the clip. As with installation, preferably only one end of the frame is removed at a time.

Alternatively, with both installation and removal, a side of the frame may be firstly installed instead of a top or bottom end. The installer follows the same procedure in that the clips located on, say, the left side of the frame are firstly engaged to the upper and lower rods and pressure is applied thereto so that the rod makes its way into the housing portions of the flexible arms.

One of skill in the art will appreciate that depending upon the application, a single mounting rod may be used with corresponding mounting clips positioned on the frame. Moreover, it may be envisioned that a single mounting clip with a corresponding rod may be used as well. It is also within the scope of this invention to used more than two mounting rods to secure a frame having mounting clips arranged thereon to correspond to the multiple mounting rods. Such an application may be, for example, to affix a particularly large or heavy object to a substrate.

It is also not beyond the scope of this invention in that the mounting rods include a different shape such that they may include cross-sections having square, triangular, rectangular, polygonal, oval and irregular shapes. Of course, for such alternative shapes, the clips are correspondingly formed such that the housing portions may amply receive the alternative mounting rods and retain them therein comparable to the cylindrical mounting rod and curved housing portion of the clip of the preferred embodiment.

Moreover, it is also not beyond the scope of this invention in which a “ball and socket” securing rod and clip mechanism are used. Specifically, in place of the mounting rod, a ball shaped mount is affixed to the substrate to correspond to a corner of the frame. The clip in this embodiment is formed such that it includes at least three flexible arms with housing portions corresponding to the shape of the ball.

Still further yet, it is not beyond the scope of this invention in which a retaining recess or opening is positioned along the mounting rod to receive a retaining member of the clip.

One of skill in the art will also appreciate that although the present invention is shown together with fastening means comprising fasteners, screws, nuts-bolts and the like, other fastening means including welding, adhesive, and interlocking members may be used and are within the scope of the invention.

While the processes illustrated herein may be described as a series of consecutive steps, none of these processes are limited to any particular order of the described steps. Additionally, it should be understood that the various illustrative embodiments (the process, system and components thereof) of the present invention described above have been presented by way of example only, and not limitation. Thus, the breadth and scope of the present invention should not be limited by any of the above-described exemplary embodiments, but should be defined only in accordance with the following claims and their equivalents.

What is claimed is:

1. A method for securing a frame to a substrate comprising:
affixing a rod to a wall for securing a frame;
affixing at least one flexible clip to an affixing side of the frame creating an affixable frame,
engaging the clip in contact with the rod;
forcing the affixable frame towards the rod, wherein the flexible clip flexes to receive and secure the rod therein.

2. The method according to claim 1, wherein the rod includes a predetermined thickness.

3. The method according to claim 2, wherein the clip comprising a receiving side having two flexible arms spaced apart from one another a distance being equal to or less than the predetermined thickness, where each arm includes a housing portion for housing the rod.

4. The method according to claim 3, wherein upon the forcing of the affixable frame toward the rod, the flexible arms are forced apart to receive the rod therebetween and rest within the housing portion of each flexible arm.

5. The method according to claim 1, wherein the rod includes a cross-section selected from the group consisting of: circular, oval, square, rectangular, polygonal and irregular.

6. The method according to claim 1, wherein the rod includes a substantially cylindrical shape comprising a substantially fixed curved surface throughout corresponding substantially to a predetermined diameter.

7. The method according to claim 6, wherein the clip includes a shape substantially corresponding to the curved surface of the rod.

8. The method according to claim 1, wherein the rod is affixed to the substrate in a substantially horizontal direction.

9. The method according to claim 1, wherein the rod includes a length which is less than or equal to a width of the frame.

10. The method according to claim 1, wherein the frame includes a length in the vertical direction having a top and a bottom and a width in the horizontal direction having a left side and a right side, and wherein the clip is affixed to the affixing side of the frame at a point substantially equidistant between the top and bottom and between the left side and the right side.

11. The method according to claim 1, wherein the frame includes a length in the vertical direction having a top and a bottom and a width in the horizontal direction having a left side and a right side, and wherein the clip is affixed to the affixing side of the frame at a point closer to the top of the frame than to the bottom and substantially equidistant between the left side and the right side.

12. The method according to claim 1, further comprising a plurality of clips affixed to the affixing side of the frame are arranged thereon to correspond to length of the rod.

13. The method according to claim 1, further comprising a plurality of rods affixed to the wall, each spaced apart from one another correspondingly between a top and a bottom of the frame, and further comprising a plurality of clips affixed to the affixing side of the frame and arranged thereon to correspond to at least one of the rods.

14. The method according to claim 1, wherein the frame comprises a panel.

15. The method according to claim 1, wherein the frame comprises a perimeter of a shape.

16. The method according to claim 15, wherein the shape is selected from the group consisting of: square, rectangular, triangular, oval, circular, polygonal and irregular.

17. The method according to claim 1, wherein the panel is releasably affixed to the substrate.

18. The method according to claim 1, wherein to release the frame from the substrate, the method further comprises placing a force on the frame in a direction away from the substrate and wherein the force compels the flexible clip to release the rod.

19. The method according to claim 3, wherein to release the frame from the substrate, the method further comprises placing a force on the frame in a direction away from the substrate and wherein the flexible arms to move apart thereby allowing the rod to pass out of the housing portion.

20. The method according to claim 1, wherein the rod includes an affixing portion for securing the rod to the substrate.

21. The method according to claim 1, wherein the affixing portion comprise an opening from a first side of the rod to a second side of the rod, the openings for receiving and passing a fastener from the first side to the second side, and wherein a portion of the fastener passing through the second side is received by the substrate for securing therein.

22. The method according to claim 1, wherein the rod is substantially linear.

23. The method according to claim 1, wherein the substrate comprises a wall.

24. A method for releasably securing a frame to a wall comprising:
affixing a first substantially linear rod to a wall in a substantially horizontal direction for securing a top portion of the frame;
affixing a second substantially linear rod to a wall in a substantially horizontal direction for securing a bottom portion of the frame, wherein the second rod is spaced away from the first rod, each rod includes a substantially cylindrical shape comprising a substantially fixed curved surface throughout corresponding substantially to a predetermined diameter and having a length which is equal to or less than a width of the panel;
affixing a plurality of clips to an affixing side of the frame creating an affixable frame, wherein
each clip includes a shape substantially corresponding to the curved surface of the rod and comprising a receiving side having two flexible arms spaced apart from one another a distance being equal to or less than the predetermined diameter, wherein each arm includes a housing portion for housing the rod, and
at least one clip is substantially positioned in each corner of the frame on the affixing side of the frame such that each clip in each top corner of the frame corresponds to the first rod and such that each clip in each bottom corner of the frame corresponds to the second rod;
engaging the receiving side of at least the clips positioned in the top corners of the frame or the clips positioned in the bottom corners of the frame in contact with a respective rod;
forcing the affixable frame towards the rod at the particular clips engaging a respective rod, wherein the flexible arms are forced apart to receive the rod therebetween and rest within the housing portion of each flexible arm, wherein
to release the frame from the wall, the method further comprises placing a force on the panel in a direction away from the wall compelling the flexible arms of each clip to move apart thereby allowing the rod to pass out of the housing portion and release the frame from the wall.

25. A system for securing a frame to a substrate comprising:
a rod affixed to a substrate for securing a frame thereto;
at least one flexible clip affixed to an affixing side of the frame creating an affixable frame.

26. The system according to claim 25, wherein the rod includes a predetermined thickness.

27. The system according to claim 26, wherein the clip comprises a receiving side having two flexible arms spaced apart from one another a distance being equal to or less than the predetermined thickness, where each arm includes a housing portion for housing the rod.

28. The system according to claim 27, wherein upon a forcing of the affixable frame toward the rod to mount the frame to the substrate, the flexible arms are forced apart to receive the rod therebetween and rest within the housing portion of each flexible arm.

29. The system according to claim 25, wherein the rod includes a cross-section selected from the group consisting of: circular, oval, square, rectangular, polygonal and irregular.

30. The system according to claim 25, wherein the rod includes a substantially cylindrical shape comprising a substantially fixed curved surface throughout corresponding substantially to a predetermined diameter.

31. The system according to claim 30, wherein the clip includes a shape substantially corresponding to the curved surface of the rod.

32. The system according to claim 25, wherein the rod is affixed to the substrate in a substantially horizontal direction.

33. The system according to claim 25, wherein the rod includes a length which is less than or equal to a width of the frame.

34. The system according to claim 25, wherein the panel includes a length in the vertical direction having a top and a bottom and a width in the horizontal direction having a left side and a right side, and wherein the clip is affixed to the affixing side of the frame at a point substantially equidistant between the top and bottom and between the left side and the right side.

35. The system according to claim 25, wherein the frame includes a length in the vertical direction having a top and a bottom and a width in the horizontal direction having a left side and a right side, and wherein the clip is affixed to the affixing side of the frame at a point closer to the top of the panel than to the bottom and substantially equidistant between the left side and the right side.

36. The system according to claim 25, further comprising a plurality of clips affixed to the affixing side of the frame are arranged thereon to correspond to length of the rod.

37. The system according to claim 25, further comprising a plurality rods affixed to the substrate, each affixed in a substantially horizontal direction and spaced apart from one another correspondingly between a top and a bottom of the frame, and further comprising a plurality of clips affixed to the affixing side of the frame and arranged thereon to correspond to at least one of the rods.

38. The system according to claim 25, wherein the frame comprises a panel.

39. The system according to claim 25, wherein the frame comprises a perimeter of a shape.

40. The system according to claim 39, wherein the shape is selected from the group consisting of: square, rectangular, triangular, oval, circular, polygonal and irregular.

41. The system according to claim 25, wherein the frame is releasably affixed to the substrate.

42. The system according to claim 25, wherein to release the frame from the substrate, the method further comprises placing a force on the frame in a direction away from the substrate and wherein the force compels the flexible clip to release the rod.

43. The system according to claim 27, wherein to release the panel from the substrate, the method further comprises placing a force on the frame in a direction away from the substrate and wherein the flexible arms to move apart thereby allowing the rod to pass out of the housing portion.

44. The system according to claim 25, wherein the rod includes a plurality of affixing portion for securing the rod to the substrate.

45. The system according to claim 44, wherein the affixing portions comprise an opening from a first side of the rod to a second side of the rod, the openings for receiving and passing a fastener from the first side to the second side, and wherein a portion of the fastener passing through the second side is received by the substrate to secure thereto.

46. The system according to claim 25, wherein said substrate comprises a wall.

47. The system according to claim 25, wherein the rod is substantially linear.

48. A system for releasably securing a frame to a wall comprising:
a first rod affixed to a wall in a substantially horizontal direction for securing a top portion of a frame, wherein the frame comprises a perimeter of polygonal or irregular shape;
a second rod spaced apart from the first rod and affixed to the wall in a substantially horizontal direction for securing a bottom portion of the frame, wherein each rod includes a substantially cylindrical shape comprising a substantially fixed curved surface throughout corresponding substantially to a predetermined diameter and having a length which is equal to or less than a width of the frame;
a plurality of clips affixed to an affixing side of the frame creating an affixable frame, each clip including a shape substantially corresponding to the curved surface of the rod and comprising a receiving side having two flexible arms spaced apart from one another a distance being equal to or less than the predetermined diameter, wherein each arm includes a housing portion for housing the rod therein and wherein the clips are arranged on the affixing side of the panel to correspond to the first and second rods such that at least two clips correspond to each rod and wherein at least one clip is affixed to each corner of the frame.

49. A frame for securing to a substrate comprising:
at least one flexible clip affixed to an affixing side of a frame creating an affixable frame, wherein the clip receives a rod affixed to a substrate for securing the frame thereto.

50. The frame according to claim 49, further comprising a plurality of clips affixed to the affixing side of the frame and arranged thereon to correspond to a length of the rod.

51. The frame according to claim 49, wherein said rod is a substantially linear rod.

52. The frame according to claim 49, wherein the rod includes a predetermined thickness.

53. The frame according to claim 49, wherein the clip comprises a receiving side having two flexible arms spaced apart from one another a distance being equal to or less than the predetermined thickness, where each arm includes a housing portion for housing the rod.

54. The frame according to claim 53, wherein upon the forcing of the affixable panel toward the rod, the flexible arms are forced apart to receive the rod therebetween and rest within the housing portion of each flexible arm.

55. The frame according to claim 49, wherein the rod includes a cross-section selected from the group consisting of: circular, oval, square, rectangular, polygonal and irregular.

56. The frame according to claim 49, wherein the rod includes a substantially cylindrical shape comprising a substantially fixed curved surface throughout corresponding substantially to a predetermined diameter.

57. The frame according to claim 56, wherein the clip includes a shape substantially corresponding to the curved surface of the rod.

58. The frame according to claim 49, wherein the rod is affixed to the substrate in a substantially horizontal direction.

59. The frame according to claim 49, wherein the rod includes a length which is less than or equal to a width of the frame.

60. The frame according to claim 49, wherein the frame includes a length in the vertical direction having a top and a bottom and a width in the horizontal direction having a left side and a right side, and wherein the clip is affixed to the affixing side of the frame at a point substantially equidistant between the top and bottom and between the left side and the right side.

61. The frame according to claim 49, wherein the panel includes a length in the vertical direction having a top and a bottom and a width in the horizontal direction having a left side and a right side, and wherein the clip is affixed to the affixing side of the frame at a point closer to the top of the panel than to the bottom and substantially equidistant between the left side and the right side.

62. The frame according to claim 49, further comprising a plurality of clips affixed to the affixing side of the frame and arranged thereon to correspond to length of the rod.

63. The frame according to claim 49, further comprising a plurality of clips affixed to the affixing side of the frame and arranged thereon to correspond to at least one of a plurality of rods, wherein each rod is affixed to the substrate and spaced apart from one another correspondingly between a top and a bottom of the frame.

64. The frame according to claim 49, wherein the frame comprises a panel.

65. The frame according to claim 49, wherein the frame comprises a perimeter of a shape.

66. The frame according to claim 65, wherein the shape is selected from the group consisting of: square, rectangular, triangular, oval, circular, polygonal and irregular.

67. The frame according to claim 49, wherein the frame is releasably affixed to the substrate.

68. The frame according to claim 49, wherein the rod includes a plurality of affixing portion for securing the rod to the substrate.

69. The frame according to claim 68, wherein the affixing portions comprise an opening from a first side of the rod to a second side of the rod, the openings for receiving and passing a fastener from the first side to the second side, and wherein a portion of the fastener passing through the second side is received by the substrate.

70. The frame according to claim 49, wherein the substrate comprises a wall.

71. The frame according to claim 49, wherein the rod is substantially linear.

72. A releasably secured frame comprising:
a frame comprising a perimeter of a polygonal or irregular shape;
a plurality of clips affixed to an affixing side of a frame creating an affixable frame, wherein
the clips are arranged on the affixing side of the frame to correspond to a first mounting rod affixed to a wall for securing a top portion of the frame and a second mounting rod affixed to the wall for securing a bottom portion of the frame,
each rod includes a predetermined diameter and having a curved surface,
each clip includes a shape substantially corresponding to the curved surface of each mounting rod and comprising a receiving side having two flexible arms spaced apart from one another a distance being equal to or less than the predetermined diameter,
each arm includes a housing portion for housing the mounting rod therein, and
at least two clips correspond to each rod and wherein at least one clip is affixed to a predetermined portion of the frame.
